(19) United States
(12) Patent Application Publication
(10) Pub. No.: US 2015/0102941 A1
(43) Pub. Date: Apr. 16, 2015

(54) METERING DEVICE AND PARTS THEREFOR

(71) Applicant: ABB Limited, Stonehouse (GB)

(72) Inventors: Ray KEECH, Stonehouse (GB); Neil COLEMAN, Stonehouse (GB); Peter ASQUITH, Stonehouse (GB); Simon DRAPER, Stonehouse (GB)

(21) Appl. No.: 14/512,166

(22) Filed: Oct. 10, 2014

(30) Foreign Application Priority Data
Oct. 10, 2013 (GB) 1317955.1

(51) Int. Cl. G01D 4/00; H04B 7/145

(52) U.S. Cl. CPC G01D 4/002; H04B 7/145
USPC 340/870.02

(57) ABSTRACT

An industrial meter has wireless communication circuitry for communicating with a remote communication device. A repeater device allows the wireless communication circuitry of the industrial meter to continue to communicate with the remote communication device when the meter device is positioned in a location where direct communication between the wireless communication circuitry and the remote communication device is not possible (such as for example when the industrial meter is located underground).

This application is claims benefit of Serial No. 1317955.1, filed 10 Oct. 2013 in the United Kingdom and which application is incorporated herein by reference. To the extent appropriate, a claim of priority is made to the above disclosed application.

### BACKGROUND

The present invention relates to industrial metering devices (in particular industrial process meters such as flow meters, conductivity meters, power meters and the like) and to parts therefor.

Industrial measurement devices are used to take measurements of industrial processes and systems. For example, flow meters allow measurement of the flow of fluids (e.g. liquids, gases and steam) through a fluid conduit. In many cases, operators obtain measurements from such measurement devices via direct visual inspection of a display provided on the measurement device itself. In addition, operators may configure such measurement devices, for example changing them from one measurement mode to another. Such configuration is often done via physical interaction with the measurement device, for example pressing a button or trigging a light sensor by hand. Some recent proposals allow measurements to be obtained from such measurement devices and reconfigurations made to such measurement devices via a hand held computer device and using near field wireless communication techniques to communicate between the hand held device and the measurement device. However, measurement devices are often located in difficult-to-access locations, for example, they may be surrounded by pipework or located in a shaft underground, which does not allow for the use of such wireless hand held devices.

This problem could be addressed by providing the measurement device with ports for receiving an electrical cable connector in order to allow a wired connection to be made between the measurement device and the hand held device. However, the cost of providing a port for electrical connection can be relatively high, especially if waterproof connections are required; and providing different types of flow meter (one with the port and one without the port) creates other logistical problems for the supplier.

### SUMMARY

The present invention aims to at least alleviate the above problem by providing a repeater device that can improve communications with measurement devices in such difficult-to-access locations.

In order to allow communication between a user device and a measurement device that is located in a difficult-to-access location, a repeater device is provided for repeating a wireless signal between the measurement device and the remote device. The wireless signal may be a near field communication signal, a GSM signal, or any other wireless signal.

According to a first aspect, the present invention provides an industrial metering system comprising: an industrial meter device having: wireless communication circuitry for communicating information relating to the industrial meter device with an external device; and a controller for controlling the wireless communication circuitry; and a passive repeater device comprising: a first wireless coupler for positioning in close proximity to the wireless communication circuitry of the industrial meter device for wirelessly transmitting signals to and for wirelessly receiving signals from the communication circuitry of the industrial meter device; a second wireless coupler for wirelessly transmitting signals to and for wirelessly receiving signals from a remote communication device; and an electrical conductor for electrically connecting together the first wireless coupler and the second wireless coupler to allow communication between the remote communication device and the industrial meter device.

The second wireless coupler may be for coupling to a portable user device, such as a cellular telephone.

The first wireless coupler and the second wireless coupler may be inductive couplers.

The first wireless coupler and the second wireless coupler may be electromagnetic couplers.

The first wireless coupler may comprise a resonant circuit having a resonant frequency and the second wireless coupler may comprise a resonant circuit having a resonant frequency, wherein the resonant frequency of the first wireless coupler is substantially the same as the resonant frequency of the second wireless coupler.

The first wireless coupler may be mounted in a cover that attaches to a housing of the industrial meter device.

The first wireless coupler may be positioned in the cover so that when the cover is attached to the housing of the industrial meter device, the first wireless coupler is positioned adjacent the wireless communication circuitry of the industrial meter device.

The cover may comprise a fixing mechanism configured for attaching to the industrial meter device, wherein the fixing mechanism is configured such that attachment of the cover to the industrial meter device brings the first wireless coupler into close proximity to the wireless communication circuitry of the industrial meter device.

The wireless communication circuitry of the industrial meter device may be arranged to communicate using one or more of NFC communication techniques and cellular telecommunication communication techniques.

The industrial meter device may be for making and/or receiving at least one of: flow sensing measurements, conductivity sensing measurements, power sensing measurements, pressure sensing measurements, temperature sensing measurements, pH sensing measurements, position sensing measurements, force sensing measurements, level sensing measurements, industrial process measurements.

The passive repeater device may be for transferring sensor measurements to the remote communication device and/or is for transferring control signals from the remote communication device to the industrial meter device.

The control signals may include configuration and/or calibration data for configuring or calibrating the industrial meter device.

The wireless communication circuitry of the industrial meter device may comprise an antenna.

The remote communication device may comprise a base station which is communicatively coupled to a further communication device, allowing communication between the further communication device and the industrial meter device via the remote communication device and the passive repeater device.

The further communication device may comprise at least one of a portable user device and a server.

According to a second aspect, the present invention provides a passive repeater device for use in the industrial metering system of the first aspect, the passive repeater device comprising: a first wireless coupler for positioning in close proximity to wireless communication circuitry of an industrial meter device for wirelessly transmitting signals to and for wirelessly receiving signals from the communication circuitry of the industrial meter device; a second wireless coupler for wirelessly transmitting signals to and for wirelessly receiving signals from a remote communication device; and an electrical conductor for electrically connecting together the first wireless coupler and the second wireless coupler to allow communication between the remote communication device and the industrial meter device.

According to a third aspect, the present invention provides a cover for an industrial meter device, for use in the industrial metering system of the first aspect, the cover comprising: a body; a first wireless coupler mounted on the body for positioning in close proximity to wireless communication circuitry of the industrial meter device for wirelessly transmitting signals to and for wirelessly receiving signals from the communication circuitry of the industrial meter device; and a connection point located on the body for connecting the first wireless coupler to a second wireless coupler to allow communication between a remote communication device and the industrial meter device.

The connection point may comprise a port for receiving an electrical conductor which electrically connects the first wireless coupler to a second wireless coupler.

The connection point may comprise a hard-wired connection between the first wireless coupler and a second wireless coupler.

The body may comprise a fixing mechanism for attaching the cover to housing of the industrial meter device.

The fixing mechanism may be configured such that attachment of the cover to the industrial meter device brings the first wireless coupler into close proximity to the wireless communication circuitry of the industrial meter device.

According to a fourth aspect, the present invention provides a method of communicating between an industrial metering system and a remote communication node, the method comprising: providing an industrial meter device having: wireless communication circuitry for communicating information relating to the industrial meter device with an external device; and a controller for controlling the wireless communication circuitry; providing a passive repeater device comprising: a first wireless coupler for positioning in close proximity to the wireless communication circuitry of the industrial meter device for wirelessly transmitting signals to and for wirelessly receiving signals from the communication circuitry of the industrial meter device; a second wireless coupler for wirelessly transmitting signals to and for wirelessly receiving signals from a remote communication device; and an electrical conductor for electrically connecting together the first wireless coupler and the second wireless coupler to allow communication between the remote communication device and the industrial meter device; and communicating between the remote communication device and the industrial meter device by: i) communicating signals between the first wireless coupler and the communication circuitry; ii) transferring signals between the first wireless coupler and the second wireless coupler via the electrical conductor; and iii) communicating signals between the second wireless coupler and the remote communication device.

### BRIEF DESCRIPTION OF THE DRAWINGS

Embodiments of the invention will now be described, by way of example only, with reference to the attached figures in which:

FIG. 1 schematically illustrates an industrial flow meter that is installed in a pipeline located underground and a repeater device that is used to provide a coupler at ground level to allow a portable user device to communicate with the flow meter;

FIG. 2 is an electrical equivalent circuit illustrating the main components of the system shown in FIG. 1;

FIG. 3 is a cross-sectional view of a cover for an industrial measurement device which includes a repeater element of the repeater device shown in FIG. 1;

FIG. 4 schematically illustrates an industrial flow meter that is installed in a pipeline located underground and a repeater device that is used to repeat telecommunication signals at ground level to allow a user device to communicate with the flow meter via a communication node;

FIG. 5 is an electrical equivalent circuit illustrating the main components of the system shown in FIG. 4;

FIG. 6 is a cross-sectional view of a cover for an industrial measurement device which includes a repeater element of the repeater device shown in FIG. 4;

FIG. 7 is a cross-sectional view of a cover for an industrial measurement device which combines repeater elements of the repeater device shown in FIG. 1 and the repeater device shown in FIG. 4.

### DETAILED DESCRIPTION

### Near Field Repeater Device

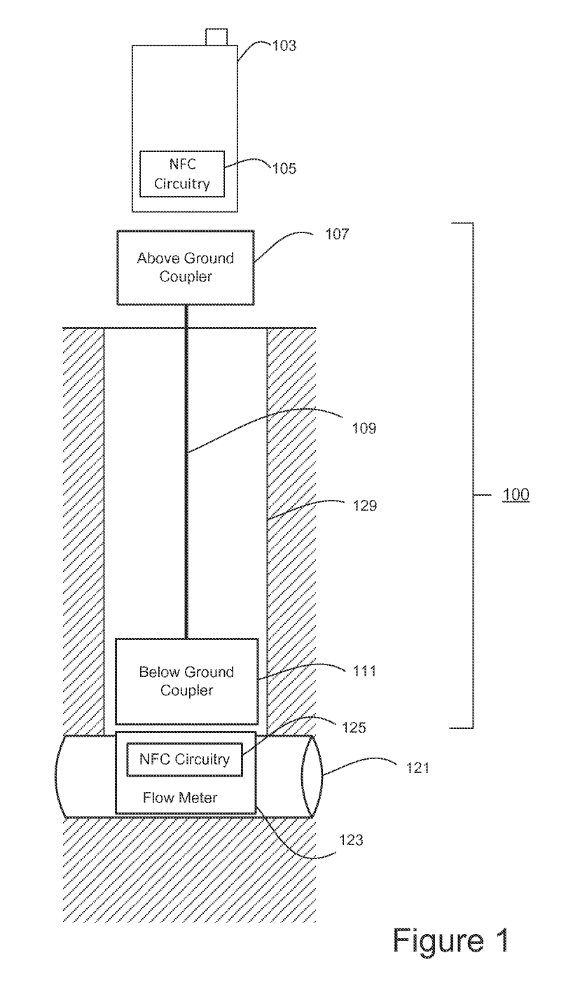

FIG. 1 shows an industrial flow meter 123 which is installed in a pipeline 121 for sensing the flow of liquid along the pipeline 121. The flow meter 123 has built-in measurement circuitry to carry out flow measurements and, in this embodiment, NFC circuitry 125 to allow a user to read the flow meter 123 from nearby using a portable handheld device 103 (such as a mobile telephone) which also has built-in NFC circuitry 105. In many installations, the user will be able to place their user device 103 directly against the flow meter housing to communicate directly with the flow meter NFC circuitry 125. However, as illustrated in FIG. 1, in some installations, the flow meter will be located in an underground shaft 129 or in some other difficult-to-access, restricted or inaccessible location. In such installations, it is not possible for the user device 103 to establish a direct communication link with the flow meter NFC circuitry 125 because the user device is too far away from the meter (typically NFC devices can communicate over a range of less than 50 cm). Therefore, as illustrated in FIG. 1, in this embodiment, an NFC repeater device 100 is provided for repeating NFC signalling between the user device NFC circuitry 105 and the flow meter NFC circuitry 125.

The NFC repeater device 100 comprises an above ground coupler 107 connected to a below ground coupler 111 via a wired link 109.

In this embodiment, the above ground coupler 107 is configured to inductively couple with the user device NFC circuitry 105 when the user device 103 is located nearby. This allows the transfer of NFC signalling between the user device 103 and the above ground coupler 107. Similarly, the below ground coupler 111 is configured to inductively couple with the flow meter NFC circuitry 125 when the flow meter 123 is located nearby. This allows the transfer of NFC signalling between the below ground coupler 111 and the flow meter 123. The wired link 109 couples NFC signals between the above ground and the below ground couplers.

Therefore, NFC signals can be transmitted between the flow meter 123 and the user device 103, via an inductive coupling between the user device NFC circuitry 105 and the above ground coupler 107, electrical signalling between the above ground coupler 107 and the below ground coupler 111 (via the wired link 109) and an inductive coupling between the below ground coupler 111 and the flow meter NFC circuitry 125.

Accordingly, the NFC repeater device 100 acts as an intermediary device allowing indirect coupling between the user device NFC circuitry 105 and flow meter NFC circuitry 125; therefore enabling communication between the mobile telephone 103 and flow meter 123 even when the flow meter 123 is located in a difficult-to-access or inaccessible position.

By providing a below ground coupler 111 which can communicate wirelessly (e.g. inductively) with the flow meter 123, the NFC repeater device 100 does not need a physical electrical connection to the flow meter 123. This is particularly advantageous because it is not necessary to provide an associated port on the flow meter itself, which can be expensive, particularly as flow meters often require waterproof ports. This also allows a standardised flow meter to be provided regardless of the location where the flow meter will be installed.

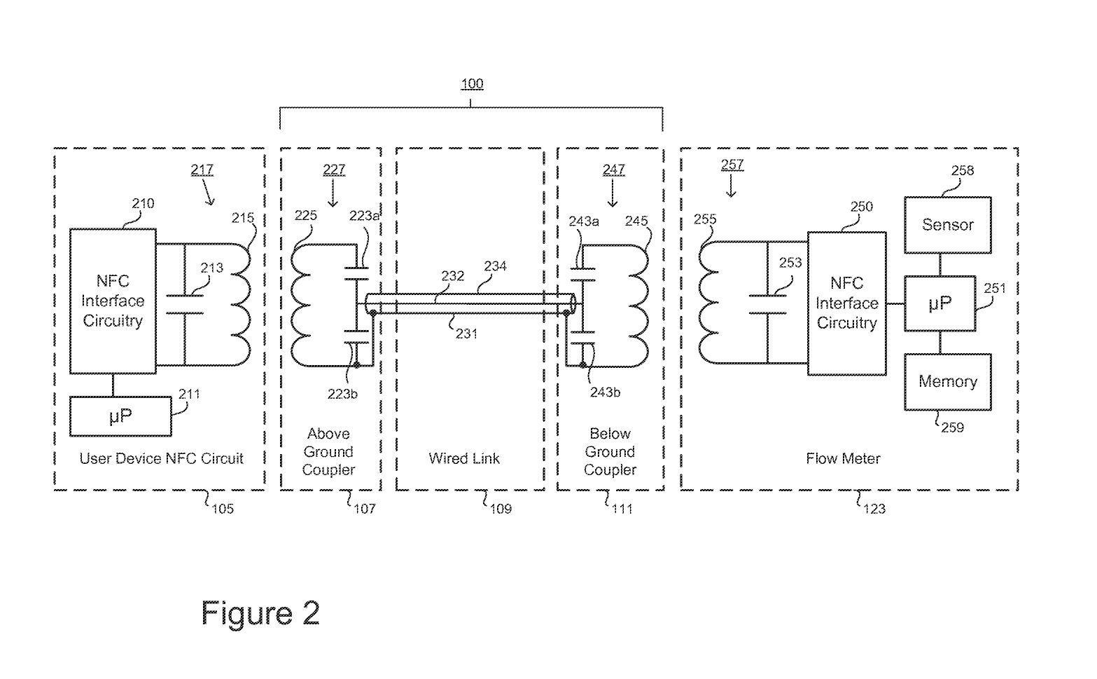

FIG. 2 is an electrical equivalent circuit illustrating the main components of the system shown in FIG. 1.

As shown, the user device NFC circuit 105 comprises a resonant circuit 217 comprising a capacitor 213 and an inductive antenna coil 215. The resonant circuit 217 is connected to NFC interface circuitry 210 which controls the application of an alternating current (or voltage) to the resonant circuit 217 via appropriate drive circuitry (not shown). In addition, the NFC interface circuitry 210 receives and processes signals received by the resonant circuit 217, for example by measuring changes in impedance or by sensing electric signals induced in the antenna coil 215. Typically, the alternating current applied to the resonant circuit 217 by the NFC interface circuitry 210 will have a frequency of 13.56 MHz (NFC standard) which is matched to the resonant frequency of the resonant circuit 217 (in order to efficiently drive the resonant circuit).

The NFC interface circuitry 210 is connected to a microprocessor 211 (which may be the main microprocessor or controller of the user device) which controls the NFC interface circuitry 210 and receives signals from it (e.g. signals received by the resonant circuit 217).

The above ground coupler 107 of the NFC repeater 100 comprises a resonant circuit 227 having an inductive antenna coil 225 connected to two capacitors 223a and 223b, which are connected in series. Similarly, the below ground coupler 111 comprises a resonant circuit 247 having an inductive antenna coil 245 connected to two capacitors 243a and 243b, which are connected in series.

In this embodiment, the wired link 109 connecting the above ground coupler 107 to the below ground coupler 111 comprises a coaxial cable 231. As shown in FIG. 2, the core 232 of the coaxial cable 231 is connected to the above ground coupler 107 at the serial connection between the capacitors 223a and 223b, and to the below ground coupler 111 at the serial connection between the capacitors 243a and 243b. A conductive shield 234 (e.g. a copper braid) of the coaxial cable is connected to a floating electrical ground point on the above ground and below ground couplers respectively.

Each pair of capacitors used in the couplers (capacitors 223a and 223b in the above ground coupler 107; capacitors 243a and 243b in the below ground coupler 111) act as a capacitive divider, allowing matching of the impedances of the resonant circuits 227, 247 and the coaxial cable 231.

As shown, the flow meter 123 comprises a resonant circuit 257 which comprises a capacitor 253 and an inductive antenna coil 255. The resonant circuit 257 is connected to NFC interface circuitry 250 which controls the application of an alternating current (or voltage) to the resonant circuit 257 via a drive circuit (not shown). The resonant frequency of the resonant circuit 257 also substantially matches with the resonant frequency of the other resonant circuits in the couplers 107, 111 and in the user NFC circuitry 105. The NFC interface circuitry 250 receives and processes signals received by the resonant circuit 257, for example by measuring changes in impedance or by sensing electric signals induced in the antenna coil 255.

The NFC interface circuitry 250 is connected to a microprocessor 251 (which may be the main microprocessor or controller of the flow meter 123) which controls the NFC interface circuitry 250 and receives signals from it (e.g. signals received by the resonant circuit 257).

The microprocessor 251 is also connected to a sensor 258 that senses fluid flowing through the pipeline 121 and to a memory 259. The microprocessor 251 controls the operation of the sensor 258 and receives measurement signals from it. The microprocessor 251 processes the measurement signals and maintains a cumulative record of the process condition being metered, which it can store in the memory 259 for subsequent output on a display or output via the flow meter NFC circuitry 125.

In operation, when a user wishes to obtain meter readings or reconfigure the flow meter 123, they approach the above ground coupler 107 with their portable user device 103. When the user device 103 is close enough to the above ground coupler 107, the NFC signals produced by the user device NFC circuitry 105 couple, in this embodiment inductively, with the above ground coupler 107 to energise the resonant circuit 227. This energisation of the resonant circuit 227 causes an electrical current to flow in the resonant circuit 227 which electric current couples into the below ground coupler 111 via the wired link 109. The electric current flowing through the below ground resonant circuit 247 creates, in this embodiment, a magnetic field that couples with the antenna coil 255 of the NFC flow meter circuitry. As a result, signals can be transmitted from the user device 103 down to the flow meter NFC circuitry 125. Similarly, signals applied to the resonant circuit 257 of the flow meter NFC circuitry 125 by the NFC interface circuitry 250 can be transmitted back to the user device 103 via the repeater device 100. In this way, the NFC repeater device 100 can be used to communicate measurements from the flow meter 123, to the user device 103 using NFC.

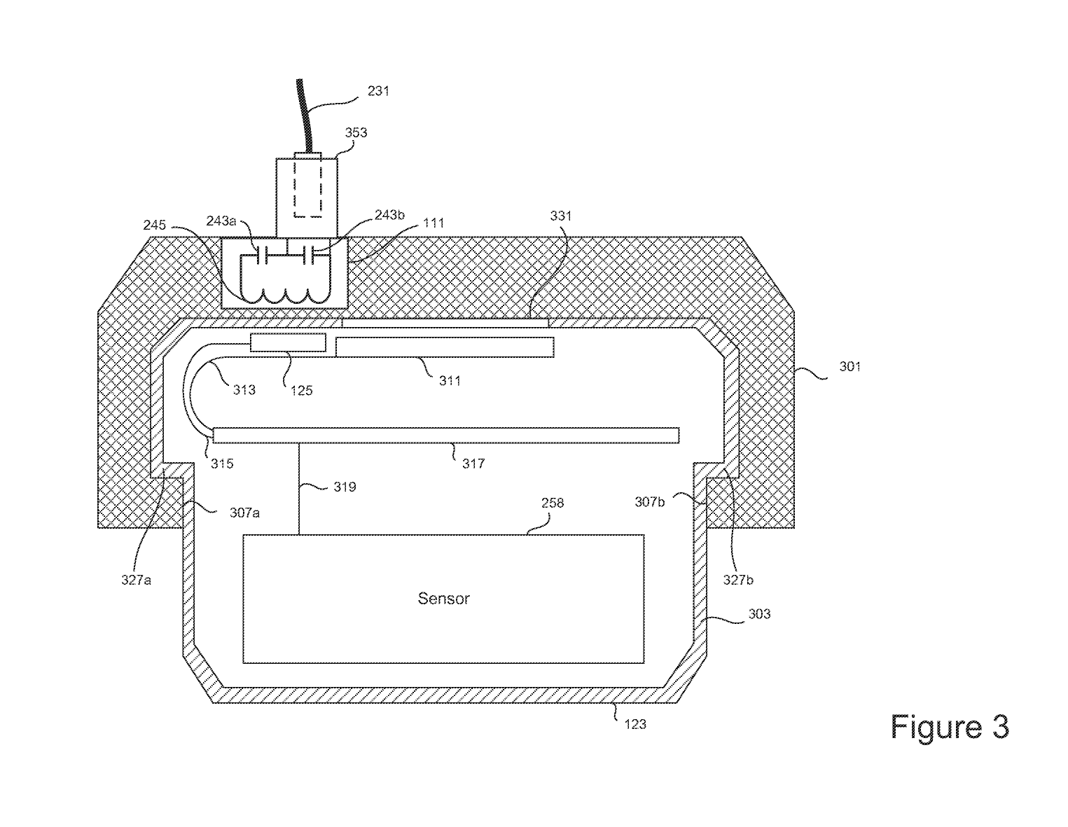

In this embodiment, the below ground coupler 111 is mounted in an end cover which fits onto the housing 303 of the flow meter 123 to ensure good coupling between the below ground coupler 111 and the flow meter NFC circuitry 125. FIG. 3 is a cross-sectional view of the end cover 301 used in this embodiment when attached to the housing 303 of the flow meter 123. As shown, the cover 301 includes the below ground coupler 111. The cover 301 also includes a port 353 which is connected to the coupler 111 and which removably receives the coaxial cable 231.

The flow meter housing 303 includes the sensor 258 which, in this embodiment, is an electromagnetic flow sensor for measuring the flow of a liquid through a pipeline. The sensor 258 is connected to a main circuit board 317 by a cable 319. The main circuit board controls the operation of the sensor 258 and the cable 319 allows two-way communication between the main circuit board 317 and the sensor 258.

The flow meter housing 303 also includes the flow meter NFC circuitry 125 which is located near the top of the flow meter housing 303 in order to minimise the distance between the NFC circuitry 125 and the coupler 111 mounted within the cover 301. The flow meter NFC circuitry 125 is connected to the main circuit board 317 via a ribbon connection 315 and the main circuit board 317 controls the operation of the NFC circuitry 125.

The cover 301 is removably attached to the flow meter housing 303. The cover 301 includes projections 307a and 307b which provide a snap fit to the flow meter housing 303 by virtue of engagement of the projections 307a and 307b with lips 327a and 327b formed in the housing 303. In order to assist this snap fit connection, the cover is preferably manufactured from a resilient material such as plastic. In this embodiment, the projections 307a and 307b are configured to engage with the housing 303 so that attachment of the cover 301 to the housing 303 brings the coupler 111 into close proximity to the flow meter NFC circuitry 125, allowing coupling between the coupler 111 and the flow meter NFC circuitry 125. More specifically, the projections 307 and the lips 327 are arranged so that the cover 301 can only engage with the housing in a desired orientation—chosen so that the coupler 111 in the body of the cover 301 is positioned immediately adjacent the location of the flow meter NFC circuitry 125 inside the flow meter housing 303. This maximises NFC signal coupling between the coupler 111 and the NFC circuitry 125.

The flow meter housing 303 also includes an LCD display 311 disposed near the top of the flow meter housing 303 and adjacent to a window 331 in the housing 303 in order to allow visual inspection of the LCD display 311. The LCD display 311 is connected to the main circuit board 317 via a ribbon connector 313 and the main circuit board 317 controls the information displayed on the LCD display 311.

### Telecommunication Repeater Device

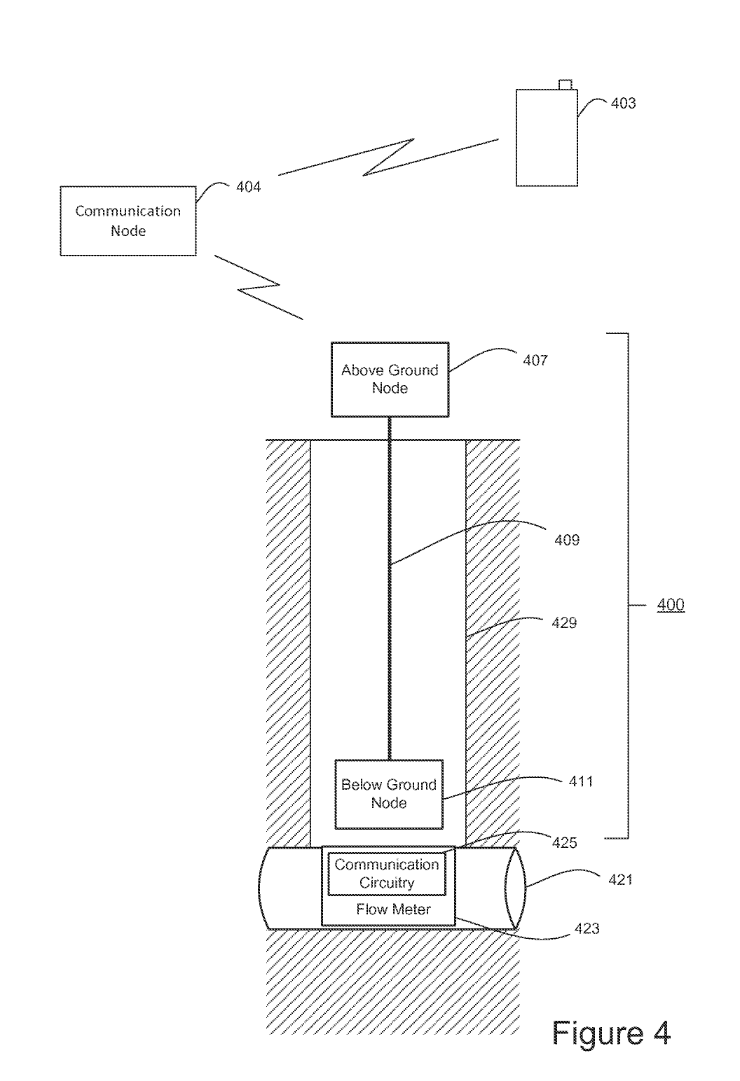

FIG. 4 shows an industrial flow meter 423 that is installed in a pipeline 421 for sensing the flow of liquid along the pipeline 421. The flow meter 423 has built-in measurement circuitry (not shown) to carry out flow measurements and, in this embodiment, communication circuitry 425 to allow a user to read the flow meter 423 remotely using a portable handheld device (such as a mobile telephone) 403 via communication within a cellular network. In many installations, the user will be able to use their cellular user device 403 to communicate with the flow meter 423 via a remote communication node 404 (which may be, for example, a base station). However, as illustrated in FIG. 4, in some installations, the flow meter will be located in an underground shaft 429 or in some other location where direct communication between the flow meter 423 and the communication node 404 is not possible, for example inside a building with no radio coverage. Therefore, as illustrated in FIG. 4, in this embodiment, a telecommunication repeater device 400 is provided for repeating telecommunication signalling between the communication node 404 and the flow meter communication circuitry 425.

The telecommunication repeater device 400 comprises an above ground node 407 connected to a below ground node 411 via a wired link 409. The wired link 409 transmits telecommunication signals between the above ground node 407 and the below ground node 411. The above ground node 407 is configured to send and receive cellular communication signals to and from the communication node 404. Similarly, the below ground node 411 is configured to send and receive cellular communication signals to and from the flow meter communication circuitry 425. The below ground node 411 is preferably within 1 m and more preferably within 5 cm of the flow meter communication circuitry 425.

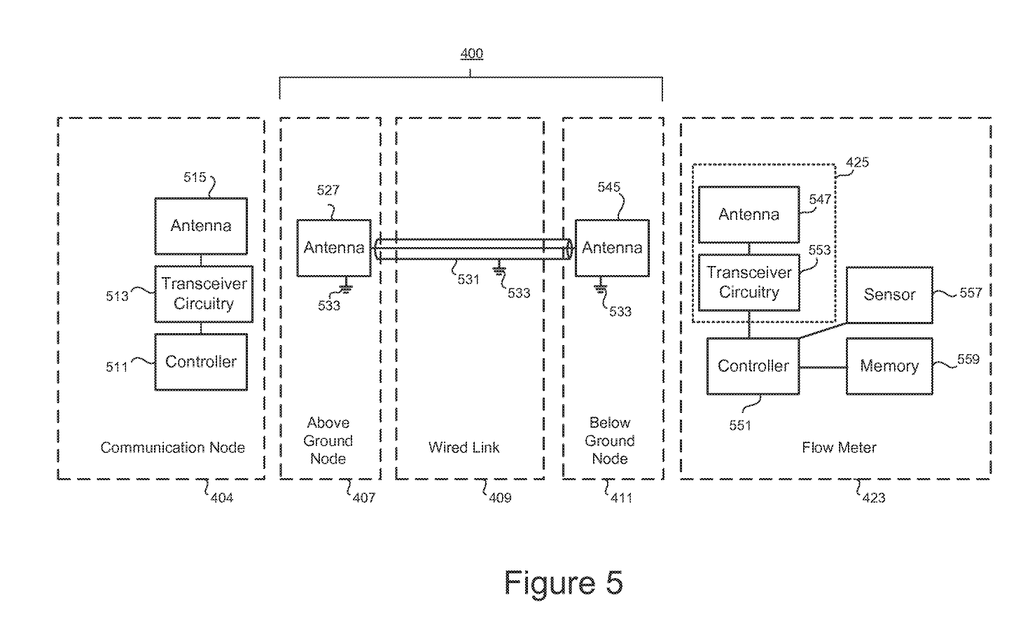

FIG. 5 is an electrical equivalent circuit illustrating the main components of the system shown in FIG. 4. As shown, the communication node 404 comprises transceiver circuitry 513 which is operable to transmit signals to, and receive signals from, the above ground node 407 via an antenna 515. The communication node 404 is also operable to transmit signals to and to receive signals from the user device 403 via the antenna 515. The operation of the transceiver circuitry 513 and the antenna 515 is controlled by a controller 511. The above ground node 407 includes a passive antenna 527 for receiving the signals transmitted from the base communication node 404, which are fed from the antenna 527 to the wired link 409. As in the first embodiment, the wired link comprises a coaxial cable which is connected to the above ground antenna 527 and to the below ground antenna 545. The below ground antenna 545 re-radiates the signals that are coupled to it via the wired link 409 for reception by the antenna 547 of the flow meter communication circuitry, which also includes transceiver circuitry 553 and a controller 551. The controller 551 is configured to control operation of the transceiver circuitry 553 and the antenna 547, and to control a sensor 557 and a memory 559. The controller 551 processes measurement signals received from the sensor 557 and maintains a cumulative record of the process condition being metered, which it can store in the memory 559 for subsequent output on a display or output via the flow meter communication circuitry. Measurement signals from the flow meter 423 can be transmitted from the antenna 547 and picked up by the antenna 545 of the below ground node 411 and then relayed to the above ground node 407, where they are radiated from the antenna 527 for reception by the communication node 404.

Thus, telecommunication signals can be transmitted between the flow meter 423 and the communication node 404, via wireless communication between the communication node 404 and the above ground node 407, electrical signalling between the above ground node 407 and the below ground node 411 (via the wired link 409) and wireless communication between the below ground node 411 and the flow meter communication circuitry 425. Accordingly, the telecommunication repeater device 400 acts as an intermediary device allowing indirect communication between the communication node 404 and the flow meter communication circuitry 425; therefore enabling a user to communicate with the flow meter 423 via the communication node 404 even when the flow meter 123 is located in low or zero signal position.

By providing a below ground node 411 which can communicate wirelessly with the flow meter 423, the telecommunication repeater device 400 does not need a physical electrical connection to the flow meter 423. This is particularly advantageous because it is not necessary to provide an associated port on the flow meter itself, which can be expensive, particularly as flow meters often require waterproof ports. This also allows a standardised flow meter to be provided regardless of the location where the flow meter will be installed.

Preferably, the wireless signalling between the communication node 404 and the above ground node 407, and between the below ground node 411 and the flow meter 423 conforms with GSM, UMTS and/or any other on telecommunication standard.

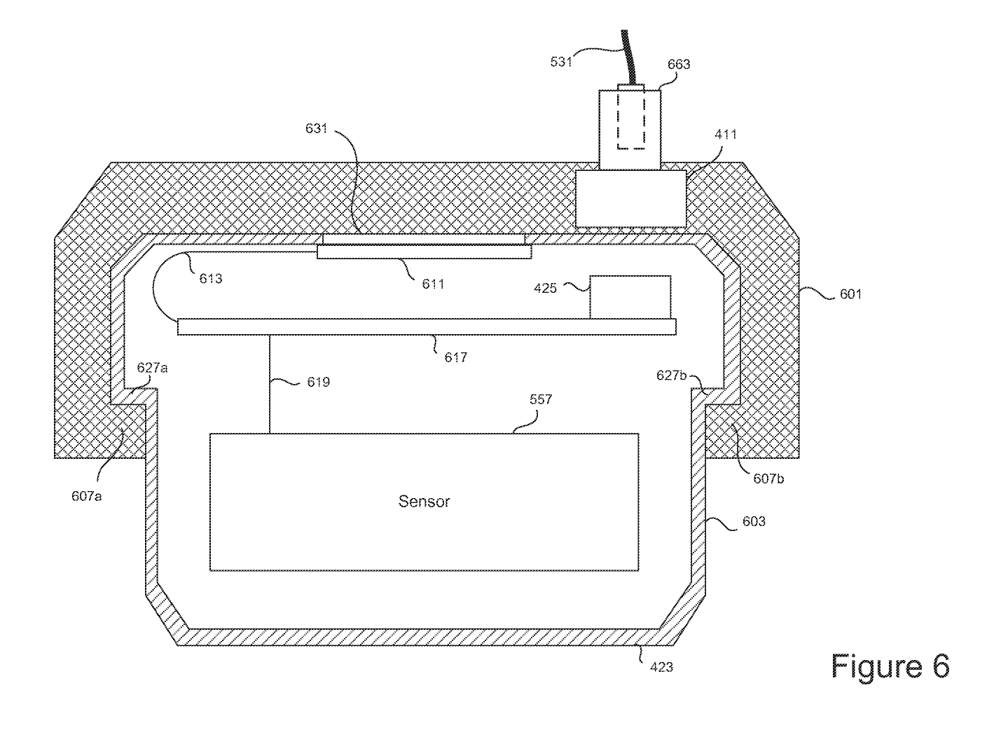

As in the first embodiment, the below ground node 411 is preferably mounted within an end cover that can be mounted onto the housing of the flow meter 423. FIG. 6 is a cross-sectional view of such an end cover 601. The cover 601 includes the below ground node 411 of the telecommunication repeater device shown in FIG. 4. The cover 601 also includes a port 663 which is connected to the below ground node 411 so that the core of the coaxial cable 531 connects to the antenna 545 of the below ground node 411.

The flow meter 423 comprises a housing 603 containing the sensor 557, which is connected to a main circuit board 617 by a cable 619. The main circuit board controls the operation of the sensor 557 and the cable 619 allows two-way communication between the main circuit board 617 and the sensor 557. The flow meter housing 603 also contains the communication circuitry 425 disposed near the top of the flow meter housing 603 in order to minimise attenuation or interference in the electromagnetic signals transmitted between the communication circuitry 425 (which, as shown in FIG. 5, includes the antenna 547 and the transceiver circuitry 553) and the below ground node 411. The communication circuitry 425 is mounted directly on the main circuit board 617. The flow meter housing 603 also includes an LCD display 611 disposed adjacent to a window 631, in order to allow visual inspection of the LCD display 611. The LCD display 611 is connected to the main circuit board 617 via a ribbon connector 613 and the main circuit board 617 controls the information displayed the LCD display 611.

The cover 601 is removably attached to the flow meter housing 603. The cover 601 includes projections 607a and 607b which provide a snap fit to the flow meter 603 by virtue of engagement of the projections 607a and 607b with lips 627a and 627b formed in the flow meter housing 603. In order to assist this snap fit connection, the cover is preferably manufactured from a resilient material such as plastic. Again, the cover 601 is designed to attach to the flow meter housing 603 in a desired orientation—so that the below ground node 411 is physically positioned adjacent the location of the flow meter communication circuitry 425 inside the flow meter housing 603. This maximises wireless signal coupling between the below ground node 411 and the flow meter communication circuitry 425

In the configuration illustrated, with the cover 601 mounted to the flow meter 603, the flow meter communication circuitry 425 is located in close proximity to the below ground node 411.

### Combined NFC and Telecommunication

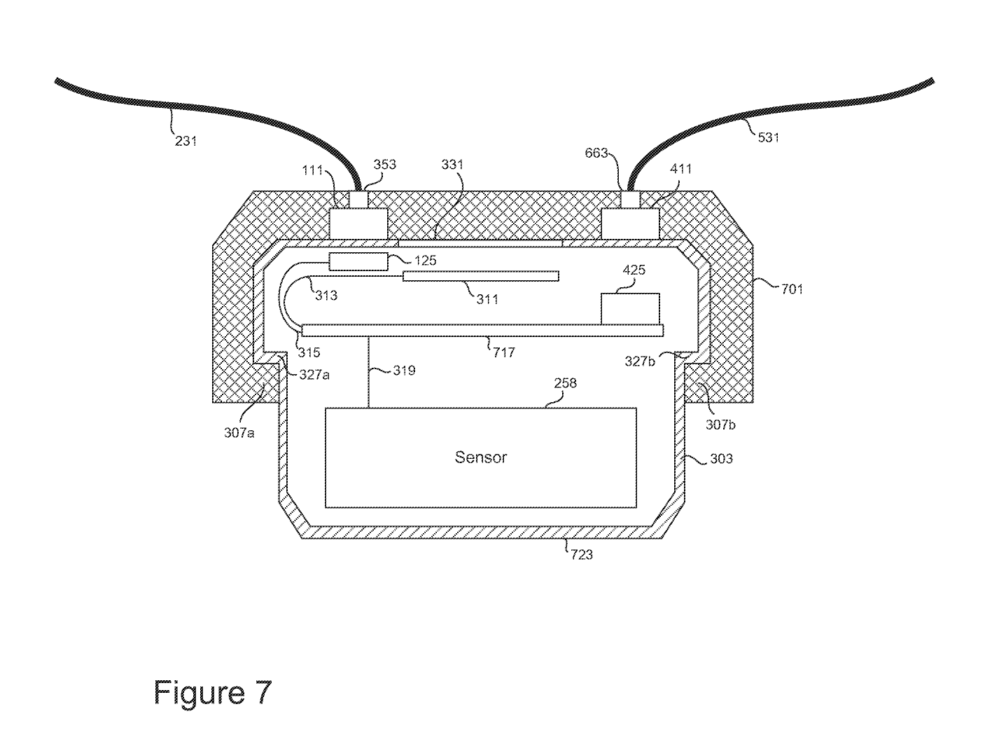

In the above two embodiments, the flow meter included either NFC communication circuitry or cellular telecommunication circuitry. In a further embodiment, both NFC and telecommunication circuitry may be provided. FIG. 7 is a cross-section of a cover 701 including elements of the NFC repeater device and the telecommunication repeater device described above, and a flow meter 723 having both NFC and telecommunication circuitry. While most of the elements present in the cover 701 and the flow meter 723 are substantially the same as those present in previous embodiments, a main circuit board 717 is provided which, unlike previous embodiments, includes circuitry configured to handle both NFC and telecommunications signals. For the remaining elements of the cover 701 and the flow meter 723 which are substantially the same as elements present in the above embodiments, like reference numerals have been used to indicate these elements, which will therefore not be described in further detail here. Again, the cover 701 is designed to attach to the housing of the flow meter 723 in only one desired orientation—so that the below ground node 411 is physically positioned adjacent the location of the flow meter communication circuitry 425 and so that the coupler 111 in the body of the cover 701 is positioned immediately adjacent the location of the flow meter NFC circuitry 125 inside the flow meter housing.

### Modifications and Alternatives

Detailed embodiments have been described above. As those skilled in the art will appreciate, a number of modifications and alternatives can be made to the above embodiments whilst still benefiting from the inventions embodied therein.

Although the embodiments described above refer to NFC and GSM telecommunications, it will be apparent to those skilled in the art that the passive repeater can be used for any type of wireless communication.

Although particularly advantageous with flow measurement devices, such as electromagnetic liquid flow meters, the above described embodiments can be used with any type of industrial measurement device.

In the above embodiments, communications protocols and interfaces conforming to the NFC standards are described. However, it will be appreciated that the embodiments described above may communicate using wireless communication which does not conform to the NFC standards, but nevertheless make use of near field magnetic and/or electric field components. For example, RFID technology may be used instead of NFC technology.

As described above, the above ground coupler 107 and the below ground coupler 111 are configured to inductively couple with the user device NFC circuitry 105 and the flow meter NFC circuitry 125 respectively; however this coupling may additionally or alternatively be electromagnetic and may additionally or alternatively be capacitive.

Therefore, NFC signals can be transmitted between the flow meter and user device via an inductive and/or electromagnetic and/or capacitive coupling between the user device NFC circuitry and the above ground coupler, electrical signalling between the above ground coupler and the below ground coupler and inductive and/or electromagnetic and/or capacitive coupling between the below ground coupler and the flow meter NFC circuitry.

In the embodiments where electromagnetic and/or capacitive coupling is used alternatively or in addition to inductive coupling, the antenna coils may be replaced with electromagnetic antennas and/or capacitive plates.

In the embodiments described herein, reference to a magnetic field may be replaced with electromagnetic field or electric field. Similarly, references to magnetic coupling or inductive coupling may be replaced with electromagnetic coupling and/or capacitive coupling.

As those skilled in the art will appreciate, the electric circuitry illustrated in the figures is illustrated in simplified form. For example, drive circuits may be provided for generating the drive signals applied to the resonant circuits. Similarly, the resonant circuits illustrated in FIGS. 2 and 3 may comprise different and/or additional components, and different arrangements may be used, provided the resonant circuits have an inductive characteristic and a capacitive characteristic sufficient to cause the resonant circuits to exhibit resonant behaviour at a desired resonant frequency. The resonant frequencies of these resonant circuits do not need to be exactly the same, but improved communication efficiency is achieved if they are substantially the same. The resonant frequencies may be between 10 MHz and 20 MHz.

Furthermore, the repeater 100 illustrated in FIG. 2 may comprise an above ground coupler and a below ground coupler, each of which comprises only a single capacitive element and a single inductive element and/or the two couplers may be connected by a single wire. The wire may be connected to any point of the resonant circuit.

Although not illustrated, there may be other similar situations in which the flow meter 123 is in a difficult-to-access location and therefore it is not possible to bring the mobile telephone 103 into close proximity to the NFC circuit of the flow meter 123. For example, the flow meter 123 may be surrounded by pipework.

In the above embodiments, the above ground device and the below ground device were connected together by a coaxial cable. As those skilled in the art will appreciate other conductive cables or balanced feeders may be used. Further, the connection between these cables and the ports of the end cover may be achieved via any suitable means. For example each of the wired links may include a male/female connector and each of the ports may include a corresponding female/male connector, where the male connector is adapted to be received by the female connector. This facilitates the connection of the cable to the below ground device. A similar female/male connector may be used to connect the cable to the above ground device.

In the above embodiments, the below ground device includes a port (e.g. port 353 in FIG. 3 and port 663 in FIG. 6). However, such a port is optional and in alternative embodiments a hard-wire connection is made between the coaxial cable and the below ground device, with the coaxial cable (or other connecting means) moulded or permanently fitted to the below ground device. A similar connection may exist between the coaxial cable and the above ground device.

The shield 234 of the coaxial cable 231 is described above as being connected to a floating electrical ground point on the above ground and below ground couplers respectively. This point at which the shield 234 is connected to the respective couplers may additionally or alternatively be the low/zero voltage part of the respective resonant circuits of the above ground and below ground couplers.

The couplers 107 and 111 of the NFC repeater device 100 may each include antenna in place of resonant circuits 227, 247.

Also, in the user device 103 and flow meter 123 the NFC interface circuitry 210, 250 is optional and may be omitted. The resonant circuits 217, 237 of the user device 103 and flow meter 123 respectively may be replaced with antennas.

In the communication circuitry 425, the transceiver circuitry 553 is optional; the communication circuitry 425 may include only an antenna, or further elements may be included in the communication circuitry, such as a microprocessor.

In the above embodiment, an end cover was provided containing the below ground circuitry. This end cover had projections that allowed the cover to snap fit onto the meter housing. As those skilled in the art will appreciate, other fixing mechanisms may be used. For example, the end cover may have a threaded portion that threads onto a thread on the meter housing.

Although reference is made to an “above ground coupler”, a “below ground coupler”, an “above ground resonant circuit”, a “below ground resonant circuit”, an “above ground node” and a “below ground node”, all of these features are not limited to above ground or below ground positioning, and can be used in any situation where direct communication with communication circuitry in the metering device cannot be achieved.

As described above, the telecommunication repeater device 400 allows communication between a user device and a flow meter. In a preferred embodiment, the user device is cellular and communications between the user device and the flow meter are transmitted via a communication node such as a base station. However, the telecommunication repeater device may be used to repeat communication signals between a flow meter and a number of other remote devices. For example, the telecommunication repeater device 400 may facilitate communication between a flow meter and a remote server, where the remote server is communicatively connected to a base station via a telephone network, and where the base station communicates with the flow meter via the telecommunication repeater device 400.

In the flow meter (e.g. 123, 423) the sensor may be omitted and optionally replaced with a sensor interface configured to receive signals from and/or transmit signals to a remote sensor or sensors.

Various other modifications will be apparent to those skilled in the art and will not be described in further detail here.

1. An industrial metering system comprising:
an industrial meter device having:
wireless communication circuitry for relating to the industrial meter device with an external device; and
a controller for controlling the wireless communication circuitry; and
a passive repeater device comprising:
a first wireless coupler for positioning in close proximity to the wireless communication circuitry of the industrial meter device for wirelessly transmitting signals to and for wirelessly receiving signals from the communication circuitry of the industrial meter device;
a second wireless coupler for wirelessly transmitting signals to and for wirelessly receiving signals from a remote communication device; and
an electrical conductor for electrically connecting together the first wireless coupler and the second wireless coupler to allow communication between the remote communication device and the industrial meter device.

2. An industrial metering system according to claim 1, wherein the second wireless coupler is adapted for coupling to a portable user device, such as a cellular telephone.

3. An industrial metering system according to claim 1, wherein the first wireless coupler and the second wireless coupler are inductive couplers.

4. An industrial metering system according to claim 1, wherein the first wireless coupler and the second wireless coupler are electromagnetic couplers.

5. An industrial metering system according to claim 1, wherein the first wireless coupler comprises a resonant circuit having a resonant frequency and the second wireless coupler comprises a resonant circuit having a resonant frequency, and wherein the resonant frequency of the first wireless coupler is substantially the same as the resonant frequency of the second wireless coupler.

6. An industrial metering system according to claim 1, wherein the first wireless coupler is mounted in a cover that attaches to a housing of the industrial meter device.

7. An industrial metering system according to claim 6, wherein the first wireless coupler is positioned in the cover so that when the cover is attached to the housing of the industrial meter device, the first wireless coupler is positioned adjacent the wireless communication circuitry of the industrial meter device.

8. An industrial metering system according to claim 7, wherein the cover comprises a fixing mechanism configured for attaching the cover to the industrial meter device, wherein the fixing mechanism is configured such that attachment of the cover to the industrial meter device brings the first wireless coupler into close proximity to the wireless communication circuitry of the industrial meter device.

9. An industrial metering system according to claim 1, wherein the wireless communication circuitry of the industrial meter device is arranged to communicate using one or more of NFC communication techniques and cellular telecommunication communication techniques.

10. An industrial metering system according to claim 1, wherein the industrial meter device is adapted for making and/or receiving at least one of: flow sensing measurements, conductivity sensing measurements, power sensing measurements, pressure sensing measurements, temperature sensing measurements, pH sensing measurements, position sensing measurements, force sensing measurements, level sensing measurements, industrial process measurements.

11. An industrial metering system according to claim 1, wherein the passive repeater device is adapted for transferring sensor measurements to the remote communication device and/or adapted for transferring control signals from the remote communication device to the industrial meter device.

12. An industrial metering system according to claim 11, wherein the control signals include configuration and/or calibration data for configuring or calibrating the industrial meter device.

13. An industrial metering system according to claim 1, wherein the wireless communication circuitry of the industrial meter device comprises an antenna.

14. An industrial metering system according to claim 1, wherein the remote communication device comprises a base station which is communicatively coupled to a further communication device, allowing communication between the further communication device and the industrial meter device via the remote communication device and the passive repeater device.

15. An industrial metering system according to claim 14, wherein the further communication device comprises at least one of a portable user device and a server.

16. A passive repeater device for use in the industrial metering system according to claim 1, comprising:
a first wireless coupler adapted for positioning in close proximity to wireless communication circuitry of an industrial meter device adapted for wirelessly transmitting signals to and for wirelessly receiving signals from the communication circuitry of the industrial meter device;
a second wireless coupler adapted for wirelessly transmitting signals to and for wirelessly receiving signals from a remote communication device; and
an electrical conductor adapted for electrically connecting together the first wireless coupler and the second wireless coupler to allow communication between the remote communication device and the industrial meter device.

17. A cover for an industrial meter device, for use in the industrial metering system according to claim 1, comprising:
a body;
a first wireless coupler mounted on the body adapted for positioning in close proximity to wireless communication circuitry of the industrial meter device adapted for wirelessly transmitting signals to and for wirelessly receiving signals from the communication circuitry of the industrial meter device; and
a connection point located on the body adapted for connecting the first wireless coupler to a second wireless coupler to allow communication between a remote communication device and the industrial meter device.

18. The cover according to claim 17, wherein the connection point comprises a port configured for receiving an electrical conductor which electrically connects the first wireless coupler to a second wireless coupler.

19. The cover according to claim 17, wherein the connection point comprises a hard-wired connection between the first wireless coupler and a second wireless coupler.

20. The cover according to claim 17, wherein the body comprises a fixing mechanism configured for attaching the cover to housing of the industrial meter device.

21. The cover according to claim 20, wherein the fixing mechanism is configured such that attachment of the cover to the industrial meter device brings the first wireless coupler into close proximity to the wireless communication circuitry of the industrial meter device.

22. A method of communicating between an industrial metering system and a remote communication node, the method comprising:
providing an industrial meter device having:
wireless communication circuitry adapted for communicating information relating to the industrial meter device with an external device; and
a controller adapted for controlling the wireless communication circuitry;
providing a passive repeater device comprising:
a first wireless coupler adapted for positioning in close proximity to the wireless communication circuitry of the industrial meter device adapted for wirelessly transmitting signals to and for wirelessly receiving signals from the communication circuitry of the industrial meter device;
a second wireless coupler adapted for wirelessly transmitting signals to and for wirelessly receiving signals from a remote communication device; and
an electrical conductor adapted for electrically connecting together the first wireless coupler and the second wireless coupler to allow communication between the remote communication device and the industrial meter device; and communicating between the remote communication device and the industrial meter device by:
i) communicating signals between the first wireless coupler and the communication circuitry;
ii) transferring signals between the first wireless coupler and the second wireless coupler via the electrical conductor; and
iii) communicating signals between the second wireless coupler and the remote communication device.
